(19) United States
(12) Patent Application Publication
(10) Pub. No.: US 2026/0253519 A1
(43) Pub. Date: Aug. 27, 2026

(54) MOTOR ASSEMBLY WITH ENVIRONMENTALLY RESISTANT FEATURES

(71) Applicant: SPECIALTY MANUFACTURING, INC., Belton, MO (US)

(72) Inventors: Christopher EGAN, Huntersville, NC (US); Howard GOLDBERG, Charlotte, NC (US); Vincent PHONG, Sherrills Ford, NC (US)

(21) Appl. No.: 19/551,836

(22) Filed: Feb. 27, 2026

Related U.S. Application Data
(60) Provisional application No. 63/764,011, filed on Feb. 27, 2025.

(51) Int. Cl. G09F 7/20; B60R 16/02; E05F 15/611; G09F 7/18

(52) U.S. Cl. CPC G09F 7/20; B60R 16/0207; E05F 15/611; E05Y 2900/506; G09F 2007/1865

(57) ABSTRACT

A motor assembly comprises a motor; a controller comprising a circuit board; and a motor housing encasing at least the motor and the controller. A connector is provided which comprises at least one metal pin connected to the circuit board, wherein a portion of the metal pin extends from an interior of the housing to an exterior of the housing, and an open-ended enclosure portion enclosing at least a portion of the at least one metal pin extending to the exterior of the housing. The connector can be structured to resist ingress of moisture and contaminants into the motor housing.

### CROSS-REFERENCE TO RELATED APPLICATION/PRIORITY CLAIM

The present application claims priority to U.S. Provisional Patent Application Ser. No. 63/764,011, filed on Feb. 27, 2025, the entirety of which is incorporated herein by reference.

### FIELD OF THE DISCLOSURE

The present disclosure generally relates to motors and motor assemblies, including motor housings and other structures which can resist the adverse effects of moisture and other environmental influences on motor performance.

### BACKGROUND

The environments in which motors are operated have constant exposure to moisture and contaminants, such as rain, snow, sleet, pooling water on roadways, wash bays, humidity, condensation, road salt, salt air, and other negative conditions in the environment. These environments include moisture and contaminants, such as rain, snow, sleet, pooling water on roadways, wash bays, humidity, condensation, road salt, salt air, and other negative conditions in the environment. Moisture or contaminant ingress into the inner workings of the motor can result in inoperability or reduced performance for the motor.

To address these issues, enhanced motor structures and configurations are needed which can resist the negative impacts of environmental moisture and contaminants on motor operation.

### BRIEF DESCRIPTION OF THE FIGURES

These and other features and characteristics of the present disclosure, as well as the methods of operation and functions of the related elements of structures and the combination of the parts and economies of manufacture, will become more apparent upon consideration of the following description and the appended claims with reference to the accompanying drawings, all of which form a part of this specification, wherein like reference numerals designate corresponding parts in the various figures.

It is to be expressly understood, however, that the drawings are for the purpose of illustration and description only, and are not intended as a definition of the limit of the disclosure. Further features will become apparent from the following detailed description made with reference to the following drawings:

FIG. 1 schematically illustrates one example of a stop arm used in connection with a school bus vehicle.

FIG. 2 schematically illustrates one example of a cross arm used in connection with a school bus vehicle.

FIGS. 3A and 3B illustrate a prior configuration for a motor assembly used for stop arm and cross arm applications.

FIG. 4 includes a portion of a perspective, partially cut-away view of one example of a motor assembly structured in accordance with certain embodiments of the present invention.

FIG. 5 includes a portion of a perspective view of another example of a motor assembly structured in accordance with certain embodiments of the present invention.

FIG. 6 includes another perspective view of the motor assembly of FIG. 5.

FIG. 7 includes a perspective view of another example of a motor assembly structured in accordance with certain embodiments of the present invention.

FIG. 8 is an alternative rendering of the motor assembly of FIG. 7, with certain portions shown in transparent form for purposes of illustrating certain internal components of the motor assembly.

FIGS. 9A through 9C include functional block diagrams which schematically illustrate different examples of various operational environments for a motor assembly structured in accordance with certain embodiments of the present invention.

### DESCRIPTION

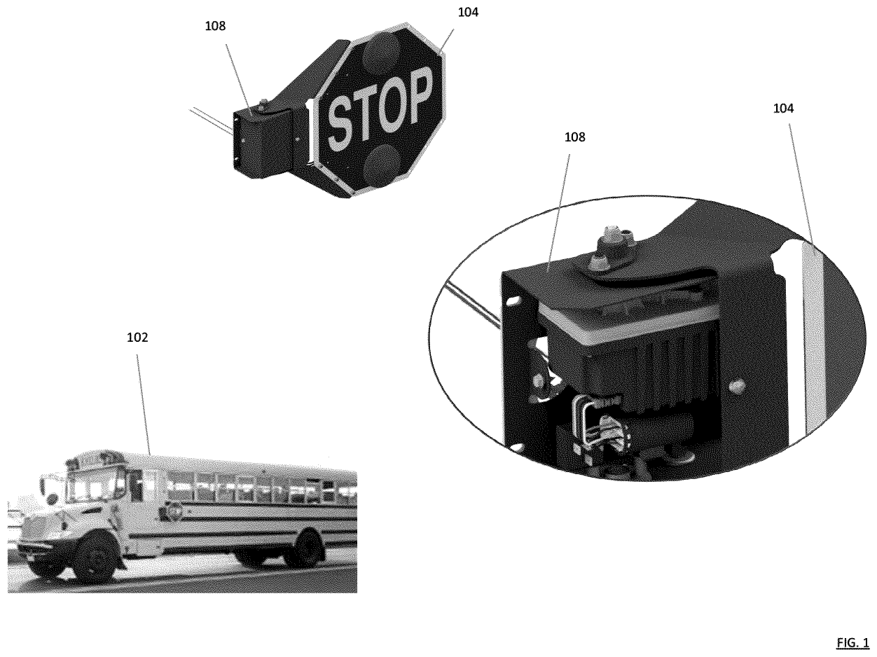

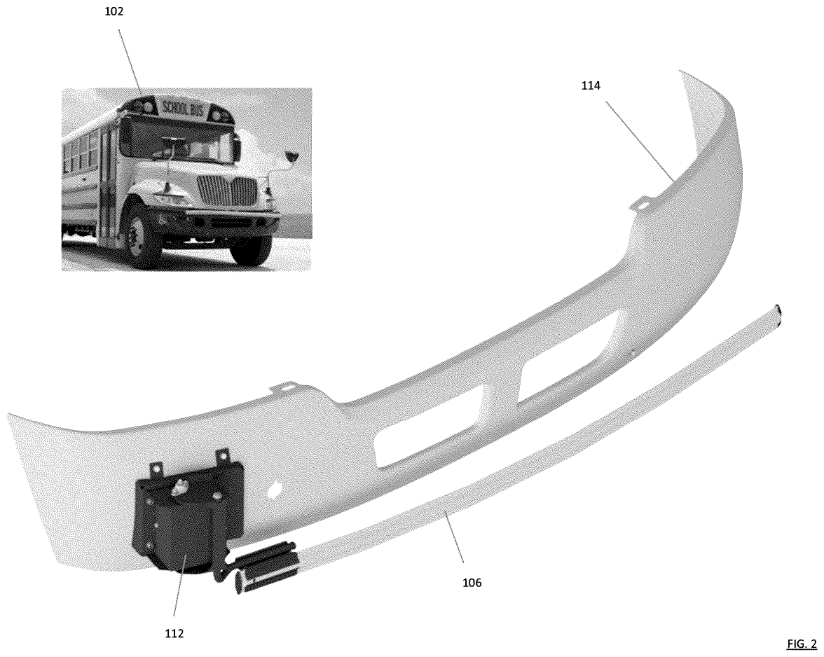

With reference to FIGS. 1 and 2, vehicles such as school buses 102 employ stop arms 104 and cross arms 106 in different types of assemblies to promote traffic control when allowing passengers to safely board onto or disembark from the vehicle. The stop arm 104 has an operatively associated stop arm motor assembly 108 which when actuated alternately extends the stop arm 104 away from, or retracts the stop arm 104 toward a side of the school bus 102. Similarly, a cross arm motor assembly 112 can be provided which when actuated alternately extends the cross arm 106 in a direction away from, or retracts the cross arm 106 in a direction toward, a bumper 114, for example, of the school bus 102.

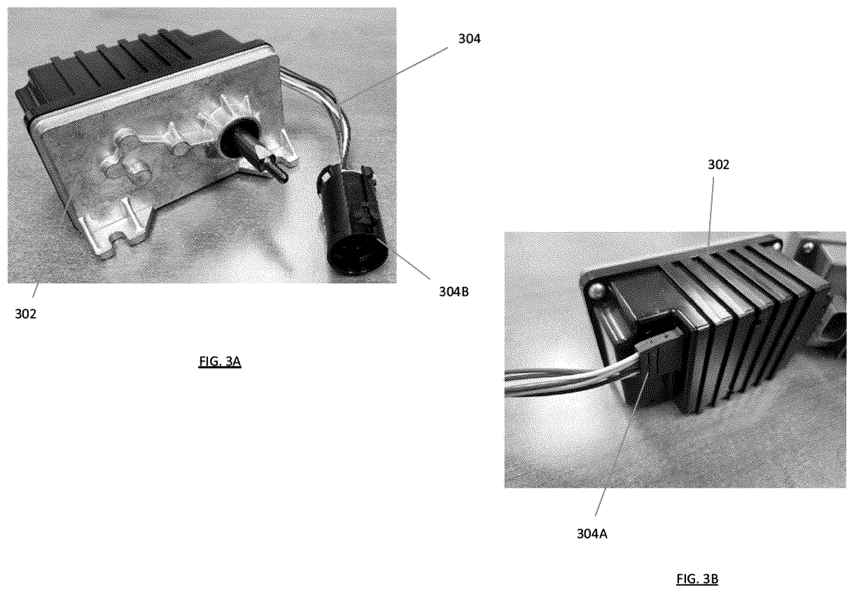

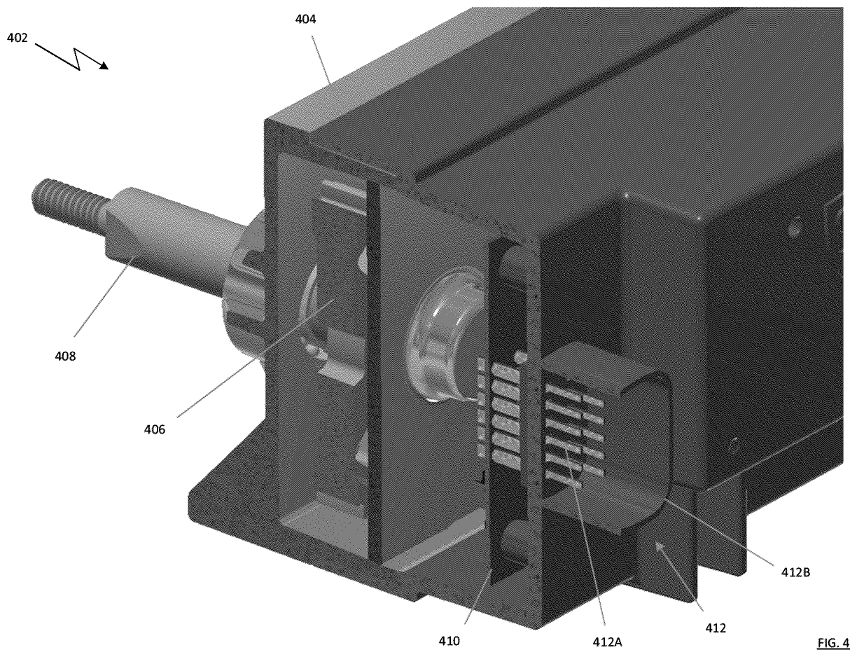

With reference to FIGS. 3A and 3B, the motor assemblies 108, 112 used in prior applications have often featured a multi-strand wire harness 304 that has a sealed connector 304A on one end which externally connects the harness 304 to the motor assembly 302 by guiding the wire strands into a connection with the motor assembly 302. At a second end of the harness 304, a molded rubber grommet 304B can be positioned which connects the harness 304 to a wiring system or electronics of the vehicle 102 on which the motor assembly 302 has been installed, for example. It can be appreciated that the wiring harness 302 can be configured to relay signals from automated, semi-automated, or operator-initiated controls inside the vehicle, for example, such as when it is desirable the actuate the cross arm 106 and/or the stop arm 104 operatively associated with the motor assembly 302.

In developing the various embodiments of the present invention, the inventors have recognized that both aspects of the wiring harness 304 have represented a point of entry for water, moisture, or other environmental contaminants, which can accumulate inside the body of the motor assembly 302 and eventually lead to motor failure or disrupted performance. The environment in which the motor performs has constant exposure to moisture and contaminants, such as rain, snow, sleet, pooling water on roadways, wash bays, humidity, condensation, road salt, salt air, and other negative conditions in the environment. The sealed connector 304A can experience water ingress as an initial point of entry into the motor assembly 302. Moisture and other contaminants come into contact with the connector 304A and travel along the wire strands of the wire harness 304, eventually entering the housing of the motor assembly 302. Accumulated moisture or contaminants inside the motor assembly 302 housing can result in inoperability or reduced performance for the motor. An additional entry point can be the grommet 304B which is a pliable material that is press-fit into a mating opening for communication with vehicle 102 systems. Variations in the molding process can also cause moisture and contaminant ingress issues which can negatively result in inoperability or reduced performance of the motor.

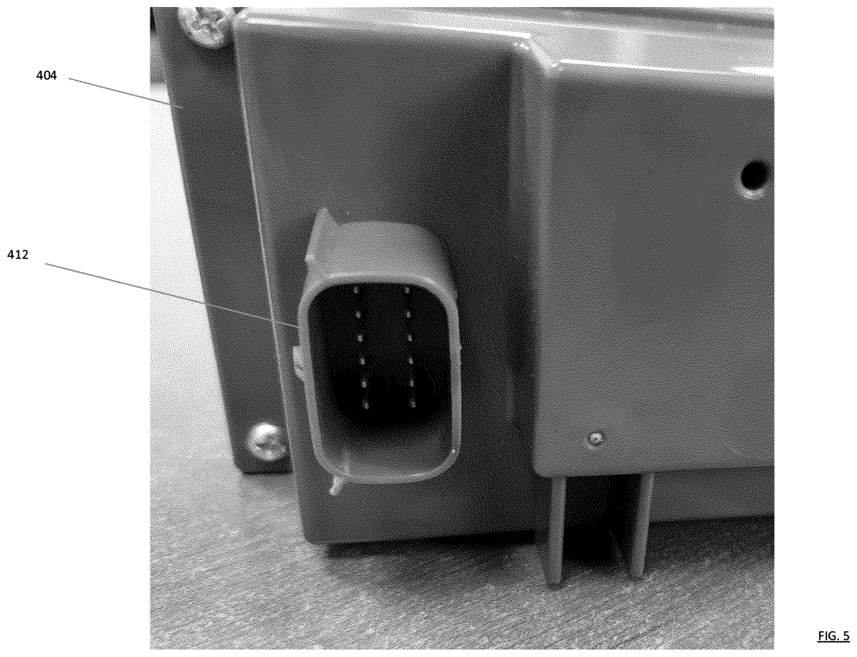

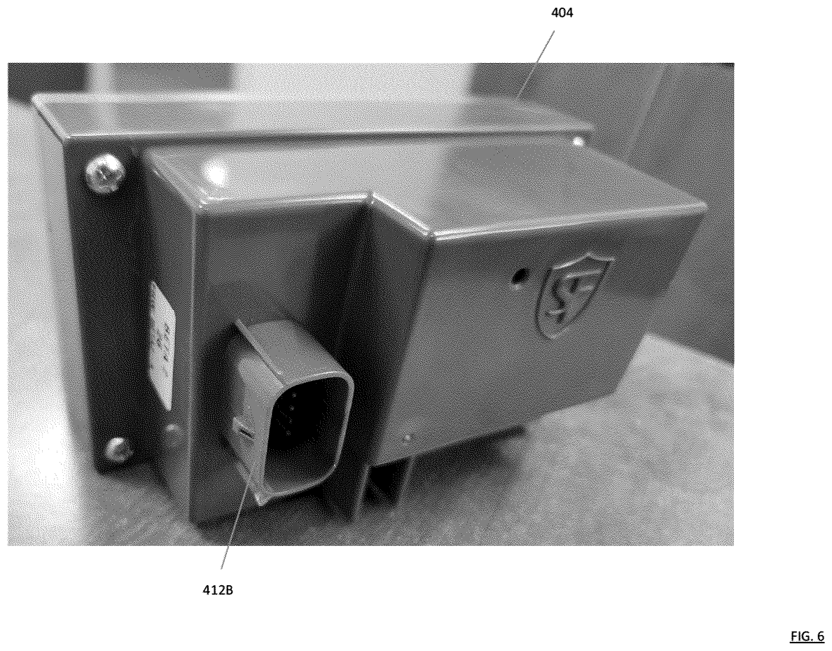

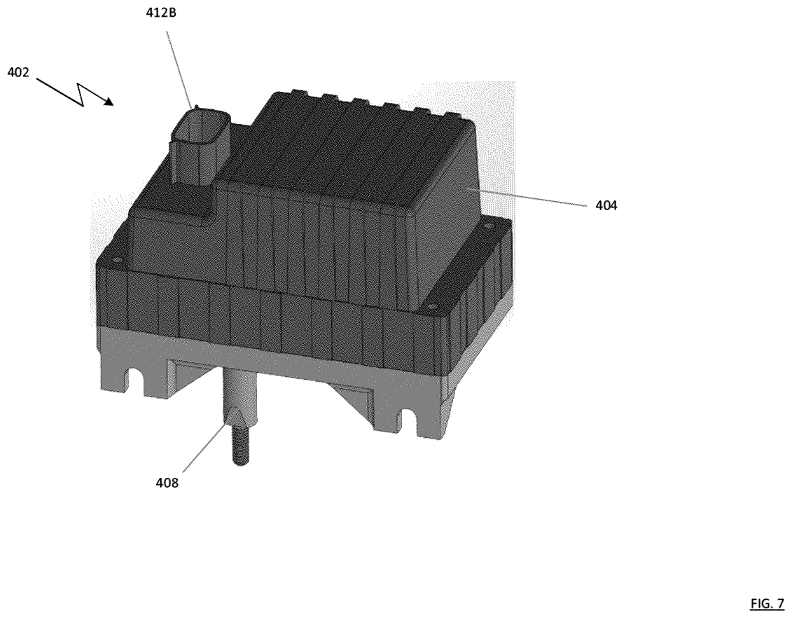

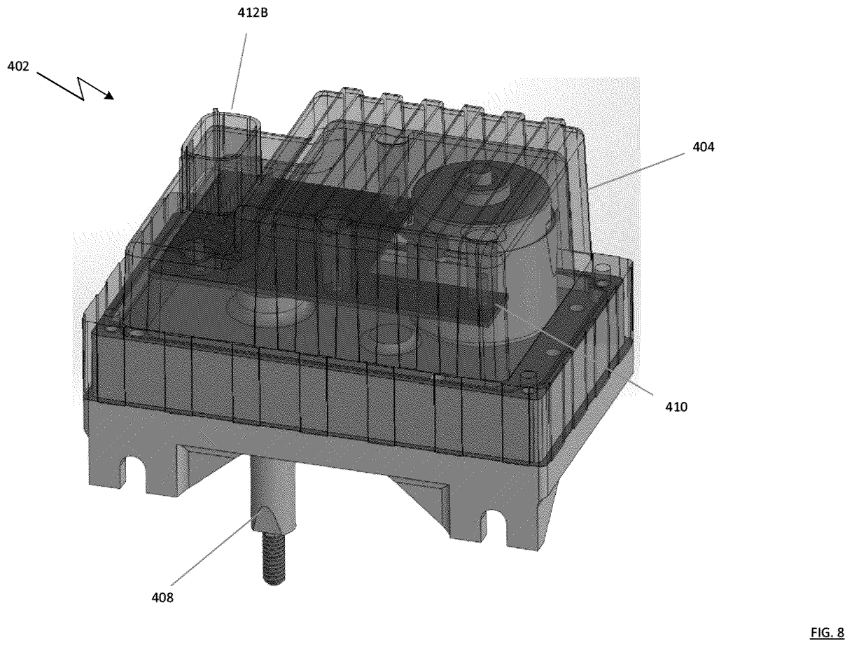

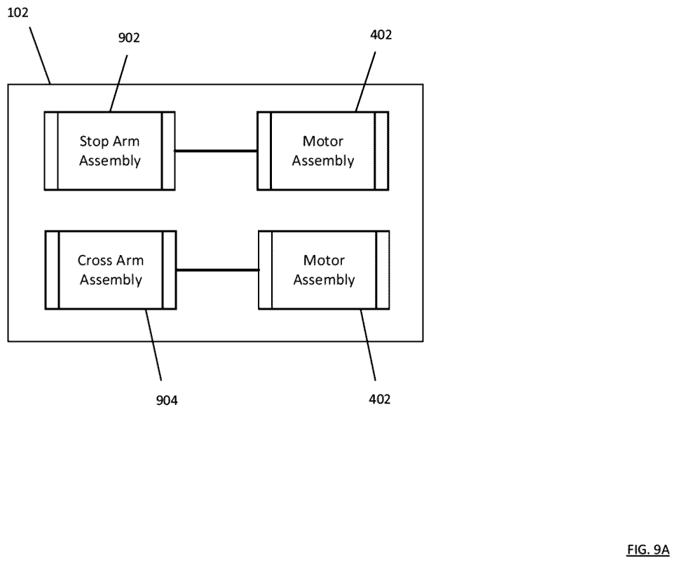

With reference to FIGS. 4 through 8, a motor assembly 402 can be provided with features for addressing the environment, contaminant, and moisture issues described above. FIGS. 4 through 8 illustrate different aspects of an enhanced motor assembly provided with features for addressing environment, contaminant, and moisture issues.

In this example, the motor assembly 402 comprises a motor housing 404 encasing a motor 406 operatively associated with an actuator shaft 408 and a controller 410. The controller 410 can be mounted on a circuit board, as shown, and the controller 410 can be programmed to process signals associated with directing the operation of the motor 406 and/or communicating with other external computer systems (e.g., vehicle 102 computer systems). A connector 412 can be provided which comprises a series of metallic pins 412A that can be molded into the housing 404 and which extend through the housing 404 to create contact with the controller 410. The metal pins 412A can be soldered to the circuit board of the controller 410, for example, thus establishing an electrical connection between the motor assembly 402 and a wiring harness (not shown) attached to the assembly 402. The connector 412 may further comprise an open-ended enclosure 412B designed to protect the portion of the metal pins 412A which extend outside the housing 404 of the assembly 402. In this manner, the assembly 402 resists moisture and other contaminants, which may travel along the wire strands of the harness, from accessing the motor assembly 402 interior.

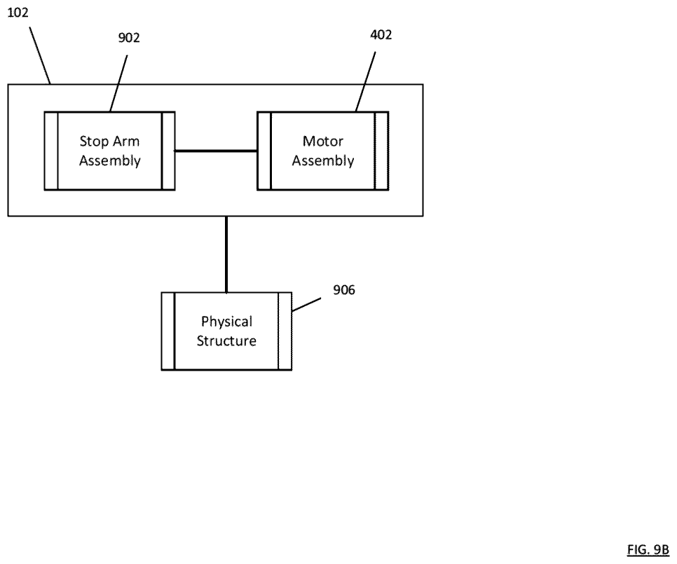

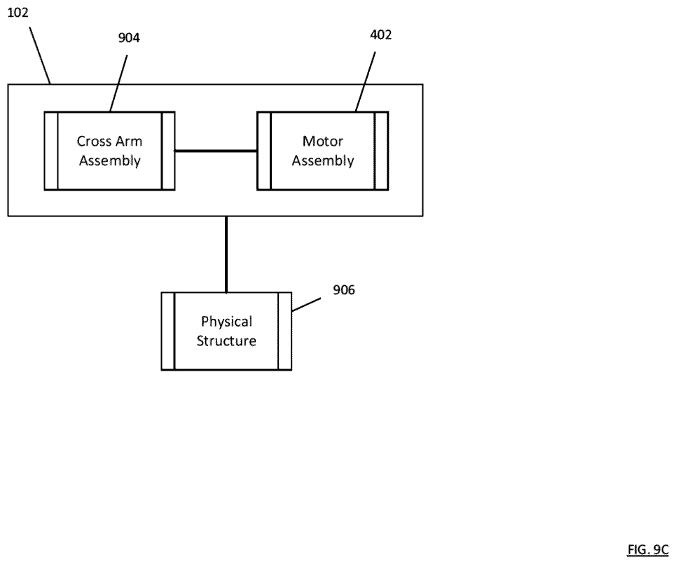

FIGS. 9A through 9C include functional block diagrams which schematically illustrates different examples of how a stop arm assembly 902 and/or a cross arm assembly 904 can be structured for use in various operational environments using a motor assembly 402. In the example shown in FIG. 9A, the stop arm assembly 902 employs the motor assembly 402 and the cross arm assembly 904 employs the motor assembly 402 installed for operation on a vehicle 102. In the example shown in FIG. 9B, the stop arm assembly 902 employs the motor assembly 402 and is installed for operation on a physical support structure 906 such as a rail, a post, a fence, a building, or another type of structure. In the example shown in FIG. 9C, the cross arm assembly 904 employs the motor assembly 402 and is installed for operation on a physical support structure 906 such as a rail, a post, a fence, a building, or another type of structure. In certain embodiments, the stop arm assembly 902 and/or the cross arm assembly 904 can be installed on other structures or assemblies, such as for use as a crossing guard at a railroad crossing, for example.

The motor assembly described herein can be used for stop arm and/or cross arm applications for vehicles, among other kinds of uses. The term “vehicle” is used herein in its broadest sense and includes all types of vehicles including ground vehicles such as animal trailers (e.g., horse trailers), all-terrain vehicles (ATVs), cars, trucks, buses, vans, heavy duty equipment, tanks, armored cars, tractors, golf carts, motorcycles, bicycles, snowmobiles, trains, railroad cars, and the like. The vehicle can also include watercraft such as, for example, ships, boats, and the like.

The motor assembly embodiments described herein can be used in many different applications, from household appliances (e.g., washers, vacuums, fans, etc.) to industrial machinery (e.g., conveyors, pumps, cranes), and transportation (e.g., electric vehicles (EVs), buses, trains, etc.). They can be useful for providing rotational or linear torque, enabling automation, and powering specialized equipment like robotics and medical devices. Motors can be used in high-power industrial applications like machinery and large HVAC systems, for example. Servo motors can be used for precision control in robotics and CNC machines, and stepper motors can be used in applications requiring exact positioning, such as three-dimensional (3D) printer applications.

For the purposes of the foregoing detailed description, it is to be understood that the disclosure can assume various alternative variations and step sequences, except where expressly specified to the contrary. Unless indicated to the contrary, any numerical parameters set forth in the specification and/or the attached claims are approximations that can vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

As used herein, the terms “upper”, “lower”, “top”, “bottom”, and derivatives thereof shall relate to the disclosure as it is oriented in the drawing figures. However, it is to be understood that the disclosure can assume various alternative orientations and, accordingly, such terms are not to be considered as limiting. Additionally, as used herein, the terms “over”, “formed over”, “provided over”, and the like mean formed and/or provided over but not necessarily in contact with the surface. For example, a layer over a transparency does not preclude the presence of one or more other layers, same or different, from being located between the layer and the transparency liner.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1.

In this application, the use of the singular includes the plural and the plural encompasses singular, unless specifically stated otherwise. In addition, in this application, the use of “or” means “and/or” unless specifically stated otherwise, even though “and/or” can be explicitly used in certain instances. As used herein, the singular form of “a”, “an”, and “the” include plural referents unless the context clearly dictates otherwise.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Whereas particular examples and embodiments of this disclosure have been described above for purposes of illustration, it will be evident to those skilled in the art that numerous variations of the details of the present disclosure may be made without departing from the disclosure as defined in the appended claims.

What is claimed is:

1. A motor assembly comprising:
a motor;
a controller comprising a circuit board;
a motor housing encasing at least the motor and the controller;
a connector comprising:
at least one metal pin connected to the circuit board, wherein a portion of the metal pin extends from an interior of the housing to an exterior of the housing, and
an open-ended enclosure portion enclosing at least a portion of the at least one metal pin extending to the exterior of the housing.

2. The motor assembly of claim 1, further comprising the controller programmed to process signals associated with directing at least one operation of the motor.

3. The motor assembly of claim 1, further comprising the connector structured to resist ingress of at least one contaminant into the motor housing.

4. The motor assembly of claim 1, further comprising the connector structured to resist ingress of moisture into the motor housing.

5. The motor assembly of claim 1, further comprising the controller programmed to process signals associated with communicating with at least one external computer system.

6. The motor assembly of claim 1, wherein the external computer system comprises a vehicle computer system.

7. The motor assembly of claim 1, wherein the connector further comprises a series of metal pins extending through the housing and in contact with the controller.

8. The motor assembly of claim 7, further comprising the series of metal pins establishing an electrical connection between the motor assembly and a wiring harness attached to the motor assembly.

9. The motor assembly of claim 7, further comprising the open-ended enclosure of the connector structured to protect the portion of the series of metal pins extending outside the motor housing.

10. The motor assembly of claim 1, further comprising the motor assembly structured for installation in a cross arme assembly of a vehicle.

11. The motor assembly of claim 10, wherein the vehicle comprises at least one of an animal trailer, an all-terrain vehicle, a car, a truck, a bus, a van, a tank, an armored car, a tractor, a golf cart, a motorcycle, a bicycle, a snowmobile, a train, a railroad car, and/or watercraft.

12. The motor assembly of claim 1, further comprising the motor assembly structured for installation in a stop arm assembly of a vehicle.

13. The motor assembly of claim 12, wherein the vehicle comprises at least one of an animal trailer, an all-terrain vehicle, a car, a truck, a bus, a van, a tank, an armored car, a tractor, a golf cart, a motorcycle, a bicycle, a snowmobile, a train, a railroad car, and/or watercraft.

14. The motor assembly of claim 1, further comprising the motor assembly structured for installation on a physical support structure.
